(19) United States
(12) Patent Application Publication
(10) Pub. No.: US 2018/0272677 A1
(43) Pub. Date: Sep. 27, 2018

(54) High Performance Semi-Rigid Wall Protection System

(71) Applicant: LSI, New Albany, IN (US)

(72) Inventor: John Serafano, Fisherville, KY (US)

(73) Assignee: LSI, New Albany, IN (US)

(21) Appl. No.: 15/927,398

(22) Filed: Mar. 21, 2018

Related U.S. Application Data
(60) Provisional application No. 62/475,626, filed on Mar. 23, 2017.

(51) Int. Cl. B32B 27/30; E04F 13/18; B32B 7/12; B32B 9/04; B32B 37/12

(52) U.S. Cl. CPC B32B 27/304; E04F 13/18; B32B 7/12; B32B 9/043; B32B 37/1207; B32B 2250/42; B32B 2419/00; B32B 2607/02; B32B 2250/05; B32B 2260/025; B32B 2266/0235; B32B 2327/06

(57) ABSTRACT

A wall protection system includes a backing layer, an intermediate layer, and a top layer. The intermediate layer is secured to the backing layer and includes a flexible polyvinyl chloride (PVC). The top layer is secured to the intermediate layer and includes a rigid PVC. In various aspects, the PVC of the intermediate layer is rigid relative to the PVC of the top layer. In certain aspects, a method of installing a wall protection system includes thermally bonding a rigid PVC layer to a flexible PVC layer. The method also includes securing a backing layer to the flexible PVC layer such that the rigid PVC layer is a top layer defining an outer surface of the wall protection system, the flexible PVC layer is an intermediate layer, and the backing layer defines an inner surface of the wall protection system.

### REFERENCE TO RELATED APPLICATIONS

This application claims the benefit of U.S. Provisional Application No. 62/475,626, filed on Mar. 23, 2017 and entitled HIGH PERFORMANCE SEMI-RIGID WALLCOVERING, the content of which is hereby incorporated by reference in its entirety.

### FIELD OF THE INVENTION

This application relates to wall protection systems and more specifically to high performance semi-rigid wall protection systems.

### BACKGROUND

Polyvinyl chloride (PVC) is used in a variety of products such as, for example, wallcoverings, flooring, upholstery, ceiling coverings, billboards and signs, decorative laminates, and various other decorative and functional applications. The PVC used is generally constructed partly of either a flexible PVC sheet or a rigid PVC sheet depending on application. As will be appreciated by those having skill in the art, flexible and soft PVC sheets/films are made flexible due to the presence of plasticizers, which are generally high boiling point organic liquids that reduces the glass transition (T_{g}) of the polymer and render the polymer more flexible and less durable. In contrast, rigid PVC plastics are made with compounds usually containing additives to improve impact resistance, such as acrylonitrile butadiene styrene (ABS), chlorinated polyethylene (CPE), and ethylene vinyl acetate (EVA), among others. These additives may be used without affecting the rigidity or tensile strength of the plastic. Rigid PVC is harder and has high impact resistance. Rigid PVC will typically have a SHORE A hardness greater than 95, whereas flexible PVC will typically have a hardness value of about 60-85 Shore A (Shore D 50). For example, rigid PVC is commonly used in packaging and not used as a wallcovering, while flexible PVC is commonly used as a flexible covering.

When individually used as a wall protection system, both the rigid PVC and the flexible PVC suffer from drawbacks. For example, rigid PVC may not process well in flexible web converting operations and is a more difficult surface to decorate, and install as a wallcovering with conventional adhesives. Flexible PVC may be susceptible to damage or other defects at its surface due to its increased flexibility and softness. For example, when the flexible PVC forms an outer surface, the flexible PVC may be susceptible to impact damage, scuffing, abrasion, scratching, or various other damage due to the decreased durability.

### SUMMARY

The subject matter of examples of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

According to various examples, a wall protection system includes a backing layer, an intermediate layer, and a top layer. The intermediate layer is secured to the backing layer and includes a flexible polyvinyl chloride (PVC). The top layer secured is to the intermediate layer and includes a rigid PVC, where the PVC of the intermediate layer is rigid relative to the PVC of the top layer.

In some examples, the top layer is secured to the intermediate layer through thermal bonding. In various aspects, the intermediate layer is secured to the backing layer through an adhesive layer. In certain embodiments, the adhesive layer includes at least one of PVC plastisol, acrylic, urethane, or ethyl vinyl acetate. According to certain cases, the backing layer defines an inner surface of the wall protection system configured to be positioned adjacent to a mounting surface during installation of the wall protection system on the mounting surface, and the top layer defines an outer surface of the wall protection system configured to be positioned distal from a mounting surface during installation of the wall protection system on the mounting surface.

In certain examples, the top layer is abrasion resistant and scratch resistant. In various cases, the top layer has less than 1% haze variation when tested according to ASTM D1044. According to various examples, top layer has less than 0.005% mass loss when tested according to ASTM D4060. In another example, the top layer is scratch resistant according to ASTM D2197 Hoffman Scratch to greater than 2000 grams of applied force. In some aspects, the top layer is chemical resistant and stain resistant. In various aspects, at least one of the top layer or the intermediate layer includes a finishing operation, and the finishing operation includes at least one of printing, embossing, coating, or laminating. According to some cases, the top layer is impact resistant to a force of 135 inch-pounds before a cavity breach on 5/8″ standard commercial drywall when tested according to ASTM D5420.

According to certain examples, a method of installing a wall protection system includes thermally bonding a rigid PVC layer to a flexible PVC layer, and securing a backing layer to the flexible PVC layer such that the rigid PVC layer is a top layer defining an outer surface of the wall protection system, the flexible PVC layer is an intermediate layer, and the backing layer defines an inner surface of the wall protection system.

In some aspects, thermally bonding the rigid PVC layer to the flexible PVC layer includes applying a temperature of from about 280° F. to about 380° F. and a pressure of from about 175 psi to about 400 psi. In various examples, securing the backing layer to the flexible PVC layer includes applying an adhesive layer to the flexible PVC layer and securing the backing layer to the adhesive layer. According to various cases, the adhesive layer comprises at least one of PVC plastisol, acrylic, urethane, or ethyl vinyl acetate.

In various examples, the method further includes applying a finishing operation to the top layer, where applying the finishing operation includes applying at least one of printing, embossing, or coating. According to certain embodiments, the finishing operation is applied to the top layer prior to thermal bonding of the top layer with the intermediate layer. In some examples, the finishing operation is applied to the top layer after thermal bonding with the intermediate layer. In certain aspects, the method further includes applying a finishing operation to the intermediate layer. In various cases, the method further includes securing the wall protection system to a mounting surface by securing the backing layer to the mounting surface.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates an example of a semi-rigid wall protection system according to aspects of the present disclosure.

FIG. 2 illustrates another example of a semi-rigid wall protection system according to aspects of the present disclosure.

### DETAILED DESCRIPTION

The subject matter of examples of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Examples of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

Disclosed herein is a high performance, semi-rigid wall protection system. In some embodiments, the wall protection system includes a top layer, an intermediate layer, and a backing layer. The intermediate layer is secured to the backing layer and includes a flexible polyvinyl chloride (PVC). The top layer secured is to the intermediate layer and includes a rigid PVC, where the PVC of the intermediate layer is rigid relative to the PVC of the top layer.

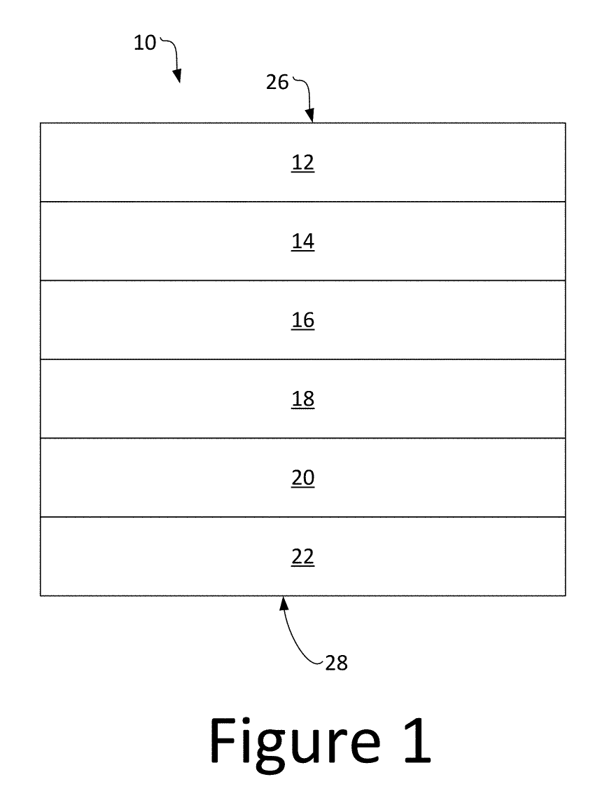

According to certain embodiments, as illustrated in FIG. 1, a wall protection system 10 may include a top layer 12, an intermediate layer 16, and a backing layer 20. Depending on a finishing operation for the wall protection system 10, a decorative layer 14 (including but not limited to a printing ink layer) is optionally provided between the top layer 12 and the intermediate layer 16. As illustrated in FIG. 1, the wall protection system 10 may further include an outer surface 26 and an inner surface 28. The inner surface 28 is configured to be positioned adjacent to a surface, such as a wall, floor, ceiling, etc., and mount the wall protection system to the surface. The outer surface 26 is configured to form an outward-facing surface that is closest to the viewer, or the surface that is distal from the surface on which the wall protection system 10 is positioned.

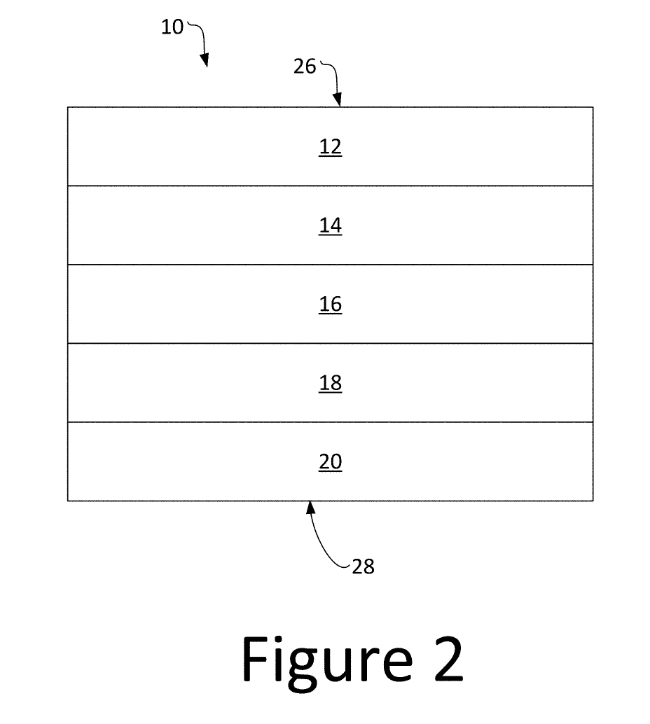

In some examples, the backing layer 20 forms the inner surface 28 (see FIG. 2). In other examples, as illustrated in FIG. 1 and as described in detail below, an optional adhesive layer 22 may form the inner surface 28. The backing layer 20 is made of any material onto which another material can be applied, and the backing layer 20, in combination with the top layer 12 and the intermediate layer 16 may provide improved impact resistance properties for the wall protection system 10. Many different materials may be used as the backing layer 20 for the wall protection system 10, including, but not limited to, woven fabrics, non-wovens, scrims, osnaburgs, or various other suitable materials. In various cases, the material used as the backing layer 20 may be varied depending on application or surface to which the wall protection system 10 is to be applied.

As illustrated in FIG. 1, in some optional examples, the wall protection system 10 includes an adhesive layer 22 provided on the backing layer 20 to form the inner surface 28. In these examples, the adhesive layer 22 may be a water-based commercial adhesive. For example, the adhesive layer 22 may be a water-based adhesive including, but not limited to, premixed adhesives based on natural polymers (such as wheat, cornstarch, etc.) on synthetic polymers, clays, viscosity modifiers, cellulose, biocides, or various other materials or combination of materials. Compared to a traditional wallcovering system, the adhesive layer 22 may allow for the wall protection system 10 to be more easily assembled and disassembled as part of a wall covering system because the water-based adhesive forming the adhesive layer 22 is more easily strippable from a wall or other mounting surface.

In various examples, both the intermediate layer 16 and the top layer 12 are PVC layers. More specifically, in various cases, the intermediate layer 16 is formed of a flexible PVC material and the top layer 12 is formed of a rigid PVC material. The flexible PVC intermediate layer 16 is flexible because plasticizers and/or other additives are combined with the PVC. In contrast, the rigid PVC that forms the top layer 12 does not include plasticizers and/or other additives to impart flexible properties to the PVC material. In the present example, the wall protection system 10 with the rigid PVC top layer 12 and the flexible PVC intermediate layer 16 may be flexible, functional, and durable for covering applications such as wallcoverings, flooring, upholstery, ceiling coverings, billboards or signs, liners, etc. In various embodiments, because the top layer 12 is the outermost layer of the wall protection system 10, the wall protection system 10 may be installed on a desired surface using installation steps similar to those used for wall protection system s that are formed entirely of rigid PVC material.

In some cases, the top layer 12 forming the outer surface 26 and constructed from the rigid PVC material may increase the impact strength of the wall protection system 10 such that the wall protection system 10 is less susceptible to scratching, denting, or various other damage due to impact. The top layer 12 may also provide a surface that is chemical resistant and/or scuff and abrasion resistant such that the wall protection system 10 has increased durability and is less susceptible to damage that may occur during use of the wall protection system 10. In some cases, the top layer 12 forming the outer surface 26 may have a gauge (or thickness) of from about 0.003 in. to about 0.020 in. (or about 0.076 mm to about 0.508 mm).

In various cases, the top layer 12 may be secured to the intermediate layer 16 without the use of adhesives or an adhesive layer. For example, in some cases, the top layer 12 is secured to the intermediate layer 16 through thermal bonding. Thermally bonding the layers may provide a smoother structure that preserves the quality the decorative layers, and may eliminate or reduce the risk of chemically contaminating the decorative layers.

In various examples, the top layer 12 may be a clear or semi-clear rigid PVC layer such that the color and/or design provided on the intermediate layer 16 is at least partially visible through the top layer 12. In some cases, the top layer 12 and the intermediate layer 16 may have any desired color or design. In some examples, the top layer 12 and/or the intermediate layer 16 may have a consistent color or may be different colors. In various cases, the top layer 12 may be opaque.

The top layer 12 and the intermediate layer 16 may be configured to undergo conversion or finishing operations including, but not limited to, printing, embossing, coating, and/or laminating. In such cases, the decorative layer 14 (including but not limited to a printing ink layer) may be provided between the top layer 12 and the intermediate layer 16. In some cases, prior to securing the top layer 12 to the intermediate layer 16 through thermal bonding, the intermediate layer 16 may undergo a desired finishing operation, such as printing to form the decorative layer 14, and the top layer 12 may also undergo a desired finishing operation, such as embossing. In various cases, the top layer 12 may undergo its finishing operation before or after the top layer 12 is secured to the intermediate layer 16.

In various cases, the intermediate layer 16 is applied to the backing layer 20 through an adhesive layer 18. The adhesive layer 18 may include various suitable adhesives for securing the intermediate layer 16 to the backing layer 20, including, but not limited to, PVC plastisol, acrylic, urethane, ethyl vinyl acetate, various combinations thereof, or various other suitable adhesives. If acrylic, urethane, ethyl vinyl acetate, or other non-PVC based adhesives are used, their formulation must include resistance to plasticizer migration. In various cases, the type of adhesive used for the adhesive layer 18 may depend on the material used as the backing layer 20.

A method of assembling the wall protection system 10 includes thermally bonding the rigid PVC top layer 12 to the flexible PVC intermediate layer 16. In some cases, thermally bonding the top layer 12 to the intermediate layer 16 includes bonding with elevated temperatures and pressures. For example, in some cases, the top layer 12 and intermediate layer 16 may be thermally bonded under non-standard machine conditions, such as elevated temperatures and/or pressures. As one example, in some cases, the thermal bonding may be at a temperature of from about 330° F. to about 380° F. In various cases, the thermal bonding may be at pressures of from about 175 psi (or about 1206 kPa) to about 400 psi (or about 2757 kPa). As one non-limiting example, in a rotary embossing process, the wall protection system 10 may reach an optimum temperature between 330° F. to 380° F. At this temperature, proper thermoforming may take place at line run speeds from 3 to 30 feet / min.

In some cases, the intermediate layer 16 undergoes conversion or finishing operations before being thermally bonded to the top layer 12. As one non-limiting example, in some cases, the intermediate layer 16 is printed. In various examples, the top layer 12 may undergo a conversion or finishing operation before or after being thermally bonded to the intermediate layer 16. As one non-limiting example, in some cases, the top layer 12 is embossed or textured after being thermally bonded to the intermediate layer 16. In various examples, the top layer 12 may be embossed under non-standard machine conditions, such as elevated temperatures and/or pressures as described previously.

The method may also include applying the backing layer 20 to the intermediate layer 16 through the adhesive layer 18 such that the backing layer 20 forms the inner surface 28 of the wall protection system 10 and the top layer 12 forms the outer surface 26 of the wall protection system 10. The backing layer 20 is configured to mount the wall protection system 10 on a surface, such as a wall or ceiling. For example, in some cases, during installation of the wall protection system 10, an adhesive is applied to the inner surface 28 or to a surface to which the inner surface 28 is configured to contact, and the adhesive bonds the backing layer 20 to the surface. In various other applications, various other techniques may be used to support the wall protection system 10 on a surface.

### EXAMPLES

### Example 1

### A Wall Protection System was Produced and Tested for Various Properties

The wall protection system included a backing layer, an intermediate PVC layer secured to the backing layer, and a top PVC layer secured to the intermediate layer through thermal bonding. The intermediate PVC layer is relatively flexible compared to the top PVC layer.

The wall protection system was tested according to ASTM D1308-02 for stain and chemical resistance against the following reagents: distilled water, ethyl alcohol 70%, vinegar (3% acetic), sulfuric acid, sodium hydroxide, soap solution, detergent solution, orange juice, butter, ketchup, tea, mustard, mayo (vegetable oil), 50% bleach, hydrogen peroxide, iodine, cola, coffee, automotive grease, 50% ammonia, 50% TSP, acetone, paint stripper, and penetrating oil. For each reagent, the reagent was applied to the outer surface of the wall protection system, remained on the outer surface for three different time periods (1 hour, 24 hours, and 96 hours), and cleaned off with water. If stain remained after cleaning with water, a 5% soap solution was used to clean the outer surface. The outer surface was then observed for damaging effects.

ASTM D1308-02 Stain and Chemical Resistance

| | 1 | | |
|---|---|---|---|
| Reagent | hour | 24 hours | 96 hours |
| Distilled Water | 0 | 0 | 0 |
| Ethyl Alcohol 70% | 0 | 0 | 0 |
| Vinegar, 3% acetic | 0 | 0 | 0 |
| Sulfuric Acid | 0 | 0 | 0 |
| Sodium Hydroxide | 0 | 0 | 0 |
| Soap solution | 0 | 0 | 0 |
| detergent solution | 0 | 0 | 0 |
| Orange Juice | 0 | 0 | 0 |
| Butter | 0 | 0 | 0 |
| Ketchup | 0 | 0 | 0 |
| Tea | 0 | 0 | 0 |
| Mustard | 0 | 0 | 0 |
| Mayo, veg oil | 0 | 0 | 0 |
| 50% Bleach | 0 | 0 | 0 |
| Hydrogen peroxide | 0 | 0 | 0 |
| Iodine | 0 | 0 | 0 |
| Cola | 0 | 0 | 0 |
| coffee | 0 | 0 | 0 |
| automotive grease | 0 | 0 | 0 |
| 50% Ammonia | 0 | 0 | 0 |
| 50% TSP | 0 | 0 | 0 |
| Acetone | 0 | 0 | 0 |
| paint stripper | 0 | 0 | 0 |
| penetrating oil | 0 | 0 | 0 |

The wall protection system was also tested according to ASTM D5420 for impact resistance. According to ASTM D5420, the wall protection system was resistant to a force of 135 inch-pounds before a cavity breach was observed on ⅝″ standard commercial drywall.

The wall protection system was further tested according to ASTM D1044 and ASTM D4060 for haze abrasion and weight loss abrasion. When tested according to ASTM D1044, the wall protection system had less than 1% haze variation. When tested according to ASTM D4060, the wall protection system had less than 0.005% mass lass. The covering substrate was further tested according to ASTM D2197 Hoffman Scratch. When tested according to ASTM D2197, the wall protection system had a resistance of greater than 2000 grams of applied force with a 100 gram stylus rider in instrument position 20.

A collection of exemplary embodiments, including at least some explicitly enumerated as “ECs” (Example Combinations), providing additional description of a variety of embodiment types in accordance with the concepts described herein are provided below. These examples are not meant to be mutually exclusive, exhaustive, or restrictive; and the invention is not limited to these example embodiments but rather encompasses all possible modifications and variations within the scope of the issued claims and their equivalents.

EC 1. A wall protection system comprising: a backing layer; an intermediate layer secured to the backing layer, the intermediate layer comprising polyvinyl chloride (flexible PVC); and a top layer secured to the intermediate layer, the top layer comprising rigid PVC, wherein the PVC of the intermediate layer is rigid relative to the PVC of the top layer.

EC 2. The wall protection system of any of the preceding or subsequent example combinations, wherein the top layer is secured to the intermediate layer through thermal bonding.

EC 3. The wall protection system of any of the preceding or subsequent example combinations, wherein the intermediate layer is secured to the backing layer through an adhesive layer.

EC 4. The wall protection system of any of the preceding or subsequent example combinations, wherein the adhesive layer comprises at least one of PVC plastisol, acrylic, urethane, or ethyl vinyl acetate.

EC 5. The wall protection system of any of the preceding or subsequent example combinations, wherein the backing layer defines an inner surface of the wall protection system configured to be positioned adjacent to a mounting surface during installation of the wall protection system on the mounting surface, and wherein the top layer defines an outer surface of the wall protection system configured to be positioned distal from a mounting surface during installation of the wall protection system on the mounting surface.

EC 6. The wall protection system of any of the preceding or subsequent example combinations, wherein the top layer is abrasion resistant and scratch resistant.

EC 7. The wall protection system of any of the preceding or subsequent example combinations, wherein the top layer has less than 1% haze variation when tested according to ASTM D1044.

EC 8. The wall protection system of any of the preceding or subsequent example combinations, wherein the top layer has less than 0.005% mass loss when tested according to ASTM D4060.

EC 9. The wall protection system of any of the preceding or subsequent example combinations, wherein the top layer is chemical resistant, stain resistant, or a combination thereof.

EC 10. The wall protection system of any of the preceding or subsequent example combinations, wherein the top layer comprises a finishing operation, and wherein the finishing operation comprises at least one of printing, embossing, coating, or laminating.

EC 11. The wall protection system of any of the preceding or subsequent example combinations, wherein the intermediate layer comprises a finishing operation.

EC 12. The wall protection system of any of the preceding or subsequent example combinations, wherein the top layer is resistant to a force of 135 inch-pounds before a cavity breach on ⅝″ standard commercial drywall when tested according to ASTM D5420.

EC 13. The wall protection system of any of the preceding or subsequent example combinations, wherein the top layer is impact resistant.

EC 14. A method of installing a wall protection system comprising: thermally bonding a rigid polyvinyl chloride (PVC) layer to a flexible PVC layer; and securing a backing layer to the flexible PVC layer such that the rigid PVC layer is a top layer defining an outer surface of the wall protection system, the flexible PVC layer is an intermediate layer, and the backing layer defines an inner surface of the wall protection system.

EC 15. The method of any of the preceding or subsequent example combinations, wherein thermally bonding the rigid PVC layer to the flexible PVC layer comprises applying an elevated temperature and an elevated pressure.

EC 16. The method of any of the preceding or subsequent example combinations, wherein the elevated temperature is a temperature from about 280° F. to about 380° F.

EC 17. The method of any of the preceding or subsequent example combinations, wherein the elevated temperature is a temperature from about 290° F. to about 370° F.

EC 18. The method of any of the preceding or subsequent example combinations, wherein the elevated temperature is a temperature from about 300° F. to about 350° F.

EC 19. The method of any of the preceding or subsequent example combinations, wherein securing the backing layer to the flexible PVC layer comprises applying an adhesive layer to the flexible PVC layer and securing the backing layer to the adhesive layer.

EC 20. The method of any of the preceding or subsequent example combinations, wherein the adhesive layer comprises at least one of PVC plastisol, acrylic, urethane, or ethyl vinyl acetate.

EC 21. The method of any of the preceding or subsequent example combinations, further comprising applying a finishing operation to the top layer.

EC 22. The method of any of the preceding or subsequent example combinations, wherein the applying the finishing operation comprises applying at least one of printing, embossing, or coating.

EC 23. The method of any of the preceding or subsequent example combinations, wherein the finishing operation is applied to the top layer prior to thermal bonding with the intermediate layer.

EC 24. The method of any of the preceding or subsequent example combinations, wherein the finishing operation is applied to the top layer after thermal bonding with the intermediate layer.

EC 25. The method of any of the preceding or subsequent example combinations, further comprising applying a finishing operation to the intermediate layer.

EC 26. The method of any of the preceding or subsequent example combinations, further comprising securing the wall protection system to a mounting surface by securing the backing layer to the mounting surface.

EC 27. The method of any of the preceding or subsequent example combinations, wherein the elevated pressure is from about 175 psi to about 400 psi.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

That which is claimed is:

1. A wall protection system comprising:
a backing layer;
an intermediate layer secured to the backing layer, the intermediate layer comprising a flexible polyvinyl chloride (PVC); and
a top layer secured to the intermediate layer, the top layer comprising rigid PVC,
wherein the PVC of the intermediate layer is rigid relative to the PVC of the top layer.

2. The wall protection system of claim 1, wherein the top layer is secured to the intermediate layer through thermal bonding.

3. The wall protection system of claim 1, wherein the intermediate layer is secured to the backing layer through an adhesive layer.

4. The wall protection system of claim 3, wherein the adhesive layer comprises at least one of PVC plastisol, acrylic, urethane, or ethyl vinyl acetate.

5. The wall protection system of claim 1, wherein the backing layer defines an inner surface of the wall protection system configured to be positioned adjacent to a mounting surface during installation of the wall protection system on the mounting surface, and wherein the top layer defines an outer surface of the wall protection system configured to be positioned distal from a mounting surface during installation of the wall protection system on the mounting surface.

6. The wall protection system of claim 1, wherein the top layer is abrasion resistant and scratch resistant.

7. The wall protection system of claim 6, wherein the top layer has less than 1% haze variation when tested according to ASTM D1044.

8. The wall protection system of claim 6, wherein the top layer has less than 0.005% mass loss when tested according to ASTM D4060.

9. The wall protection system of claim 6, wherein the top layer is scratch resistant to greater than 2000 grams when testing with ASTM D2197.

10. The wall protection system of claim 1, wherein at least one of the top layer or the intermediate layer comprises a finishing operation, and wherein the finishing operation comprises at least one of printing, embossing, coating, or laminating.

11. The wall protection system of claim 1, wherein the top layer is impact resistant to a force of 135 inch-pounds before a cavity breach on 5/8″ standard commercial drywall when tested according to ASTM D5420.

12. A method of installing a wall protection system comprising:
thermally bonding a rigid polyvinyl chloride (PVC) layer to a flexible PVC layer; and
securing a backing layer to the flexible PVC layer such that the rigid PVC layer is a top layer defining an outer surface of the wall protection system, the flexible PVC layer is an intermediate layer, and the backing layer defines an inner surface of the wall protection system .

13. The method of claim 12, wherein thermally bonding the rigid PVC layer to the flexible PVC layer comprises applying a temperature of from about 280° F. to about 380° F. and a pressure of from about 175 psi to about 400 psi.

14. The method of claim 12, wherein securing the backing layer to the flexible PVC layer comprises applying an adhesive layer to the flexible PVC layer and securing the backing layer to the adhesive layer.

15. The method of claim 14, wherein the adhesive layer comprises at least one of PVC plastisol, acrylic, urethane, or ethyl vinyl acetate.

16. The method of claim 12, further comprising applying a finishing operation to the top layer, and wherein applying the finishing operation comprises applying at least one of printing, embossing, or coating.

17. The method of claim 16, wherein the finishing operation is applied to the top layer prior to thermal bonding of the top layer with the intermediate layer.

18. The method of claim 16, wherein the finishing operation is applied to the top layer after thermal bonding with the intermediate layer.

19. The method of claim 12, further comprising applying a finishing operation to the intermediate layer.

20. The method of claim 12, further comprising securing the wall protection system to a mounting surface by securing the backing layer to the mounting surface.
